(19) United States
(12) Patent Application Publication
(10) Pub. No.: US 2015/0084402 A1
(43) Pub. Date: Mar. 26, 2015

(54) AUTOMATIC TRACTION RELAY VALVE DIAGNOSTIC USING PRESSURE TRANSDUCER FEEDBACK

(71) Applicants: Michael D. Tober, Avon, OH (US); Timothy Carritte, Avon Lake, OH (US); Timothy J. Frashure, Columbia Station, OH (US)

(72) Inventors: Michael D. Tober, Avon, OH (US); Timothy Carritte, Avon Lake, OH (US); Timothy J. Frashure, Columbia Station, OH (US)

(73) Assignee: BENDIX COMMERCIAL VEHICLE SYSTEMS LLC, Elyria, OH (US)

(21) Appl. No.: 14/038,022

(22) Filed: Sep. 26, 2013

(51) Int. Cl. B60T 17/22; B60T 11/10

(52) U.S. Cl. CPC B60T 17/221; B60T 11/103
USPC 303/20; 701/32.8

(57) ABSTRACT

A system and method of diagnosing and/or mitigating the effects of a malfunctioning brake valve configured to supply pressurized fluid to a brake unit via a pressure delivery line during automated braking operations including detecting a period of no braking activity, venting the pressure delivery line to atmosphere during the period of no braking activity, monitoring pressure in the pressure delivery line to detect a pressure change resulting from the venting, and generating an error signal if a detected pressure change exceeds a threshold value. The pressure modulating valve can be periodically cycled once a fault is detected to reduce the effects thereof.

### BACKGROUND

The present exemplary embodiment relates to a braking system for a vehicle. It finds particular application in conjunction with braking systems having automated braking functionality, and will be described with particular reference thereto. However, it is to be appreciated that the present exemplary embodiment is also amenable to other like applications.

A typical vehicle braking system for a straight truck, bus, tractor, or trailer, includes a source of pressurized air along with valves for selectively directing the air to brake chambers at the wheels of the vehicle. Vehicle air brake systems typically include a primary circuit, which is often used for driven wheels, and a secondary circuit, which is often used for non-driven wheels. A foot brake valve (FBV) is provided for enabling a user to apply the brakes. The FBV is often a valve in both the primary circuit and the secondary circuit that is controlled by a foot pedal (brake pedal) of the vehicle in response to driver demand for braking. The FBV is supplied with high pressure air from one or more reservoirs. When the FBV is actuated by driver applied force on the brake pedal, this high pressure air is directed into the primary and secondary braking circuits of the vehicle. Many such vehicle braking systems provide an antilock braking system (ABS) function, by which an electronic control unit (ECU) selectively releases and applies braking at individual wheels to prevent wheel lockup.

Some vehicle braking systems also provide an automatic traction control (ATC) function as well as other automated braking functions. In one aspect of ATC, an ECU selectively applies braking at individual wheels to match wheel speeds side to side to help control wheel spin that occurs in response to driver demand via the accelerator pedal. This control is typically effected by controlling a wheel end modulator associated with the wheel. The modulator provides an air flow path to the wheel that can be rapidly opened or closed by a solenoid under the control of the ECU.

In order to provide the ATC function, high pressure air typically is made available at the wheel end modulators in the absence of driver demand. This is commonly done by having a constant supply of high pressure air from a reservoir to an ATC solenoid that is associated with the modulators on the driven axle. In an ATC event, the ATC solenoid (relay valve) is energized under the control of the ECU to direct the high pressure air from the reservoir to the modulators. The modulators are then controlled by the ECU selectively to apply and release braking force to the wheels, to control any wheel spin. Other automated braking functions are typically initiated in the same manner, with a relay valve supplying high pressure air to the brakes and a modulator valve controlling the pressure actually delivered.

Unintended relay valve pneumatic application due to leakage or other causes is undesirable. Current system architectures may not provide warning or mitigation of this condition.

### BRIEF DESCRIPTION

The present disclosure sets forth a method of detecting a relay valve unintended pneumatic activation, warning the vehicle operator of the condition, and mitigating the effects of the activation.

In accordance with one aspect, a method of diagnosing a malfunctioning brake valve configured to supply pressurized fluid to a brake unit via a pressure delivery line during automated braking operations comprises detecting a period of no braking activity, venting the pressure delivery line to atmosphere during the period of no braking activity, monitoring pressure in the pressure delivery line to detect a pressure change resulting from the venting, and generating an error signal if a detected pressure change exceeds a threshold value.

The venting can be performed during a period when the pressure in the pressure delivery line is expected to be at or near atmosphere, whereby no change in pressure indicates a properly functioning valve. The period when the pressure in the pressure delivery line is expected to be near atmosphere includes when no braking activity is occurring. The venting the pressure delivery line to atmosphere can include actuating a pressure modulator valve operatively connected between the brake valve and the brake unit. The monitoring can include using a pressure sensor located in a service port of the brake valve to detect pressure. The venting can be performed after an unexpected increase in pressure is detected in the pressure delivery line, whereby no pressure change after venting indicates normal operation of the brake valve and the presence of electrical drift in a signal of the transducer resulting in the unexpected increase in detected pressure, and a pressure change after venting indicates a malfunctioning brake valve. The venting can be nearly instantaneous, and preferably lasting less than up to about 100 ms. The method can further comprise disabling one or more automated braking functions when an error signal is generated.

In accordance with another aspect, a brake system comprises at least one fluid pressure source, at least one brake unit, a pressure delivery line for delivering pressurized fluid to the at least one brake unit from the at least one fluid pressure source, a brake valve for controlling the flow of pressurized fluid through the pressure delivery line to the at least one brake unit during automated braking operations, the brake valve operative to supply pressurized fluid to the at least one brake unit in response to a control signal, a pressure sensor for sensing pressure in the pressure delivery line at a location between the brake valve and the brake unit, a pressure modulator valve between the brake valve and the brake unit configured to exhaust the pressurized fluid to atmosphere when actuated, and an electronic controller unit operatively connected to the pressure sensor and pressure modulator valve, the electronic control unit having an input for receiving data from the pressure sensor, an output for sending a control signal to the pressure modulator valve, a memory that stores computer-executable instructions, and a processor configured to execute the computer-executable instructions. The instructions comprise actuating the pressure modulator valve to vent the pressure delivery line to atmosphere, calculating a pressure change resulting from the venting based on data received from the pressure sensor, and generating an error signal if a detected pressure change exceeds a threshold value.

The instructions can further comprise actuating the pressure modulator valve during a period when the pressure in the pressure delivery line is expected to be at or near atmosphere, whereby no change in pressure indicates a properly functioning brake valve. The instructions can further comprise monitoring both automated and manual braking activities for periods of inactivity. The instructions can further comprise monitoring the pressure sensor for an unexpected increase in pressure, actuating the pressure modulator valve to vent the pressure delivery line to atmosphere, and comparing the pressure before and after actuation of the pressure modulator valve, whereby no pressure change after venting indicates normal operation of the brake valve and the presence of electrical drift in a signal of the sensor, and a pressure change after venting indicates a malfunctioning brake valve. The instructions can further comprise disabling at least one automated braking feature when an error signal is generated.

In accordance with another aspect, an electronic controller unit for controlling an associated pressure modulator valve adapted to vent pressure from an associated pressure delivery line of a vehicle brake system comprises an input for receiving data from at least one sensor configured to sense pressure in the associated pressure delivery line, an output for sending a control signal to the associated pressure modulator valve, a memory that stores computer-executable instructions, and a processor configured to execute the computer-executable instructions to generate the control signal. The instructions comprise monitoring data received from the at least one sensor, generating a control signal to actuate the pressure modulating valve, transmitting the control signal to the pressure modulating valve via the output to vent the pressure delivery line, detecting a pressure change resulting from the actuation of the pressure modulating valve, comparing the detected pressure change to a threshold value, and generating an error signal if the detected pressure change exceeds the threshold value.

The instructions can further comprise actuating the pressure modulator valve during a period when the pressure in the pressure delivery line is expected to be at or near atmosphere, whereby no change in pressure indicates a properly functioning brake valve. The instructions can further comprise monitoring both automated and manual braking activities for periods of inactivity. The instructions can further comprise monitoring the pressure sensor for an unexpected increase in pressure, actuating the pressure modulator valve to vent the pressure delivery line to atmosphere, and comparing the pressure before and after actuation of the pressure modulator valve, whereby no pressure change after venting indicates normal operation of the brake valve and the presence of electrical drift in a signal of the sensor, and a pressure change after venting indicates a malfunctioning brake valve. The instructions can further comprise disabling at least one automated braking feature when an error signal is generated.

In accordance with yet another aspect, a brake system comprises at least one fluid pressure source, at least one brake unit, a pressure delivery line for delivering pressurized fluid to the at least one brake unit from the at least one fluid pressure source, a brake valve for controlling the flow of pressurized fluid through the pressure delivery line to the at least one brake unit during automated braking operations, the brake valve operative to supply pressurized fluid to the at least one brake unit in response to a control signal, a pressure sensor for sensing pressure in the pressure delivery line at a location between the brake valve and the brake unit, and means for detecting a period of no braking, actuating the pressure modulator valve to vent the pressure delivery line to atmosphere, and detecting a change in pressure in the pressure delivery line resulting from the actuation of the pressure modulator valve.

In accordance with still another aspect, a method of diagnosing a brake valve configured to supply pressurized fluid to a brake unit via a pressure delivery line during automated braking operations comprises venting the pressure delivery line to atmosphere after an unexpected increase in pressure is detected in the pressure delivery line, monitoring pressure in the pressure delivery line to detect a pressure change resulting from the venting, whereby no pressure change after venting indicates normal operation of the brake valve and the presence of electrical drift in a signal of the transducer resulting in the unexpected increase in detected pressure, and a pressure change after venting indicates a malfunctioning brake valve, and generating an error signal if a pressure change is detected.

The method can further comprise detecting a period of no braking activity, and venting the pressure delivery line to atmosphere during the period of no braking activity. The venting the pressure delivery line to atmosphere can include actuating a pressure modulator valve operatively connected between the brake valve and the brake unit. The method can also include taking mitigating action when an error signal is generated, the mitigating action including at least one of illuminating a warning lamp, periodically cycling the pressure modulator valve, or disabling one or more automated braking functions.

### BRIEF DESCRIPTION OF THE DRAWINGS

FIG. 1 is schematic diagram of a prior art brake system;

FIG. 2 is a schematic diagram of an exemplary brake system in accordance with the present disclosure;

FIG. 3 is a block diagram of an exemplary controller in accordance with the present disclosure; and

FIG. 4 is a flowchart illustrating an exemplary method in accordance with the present disclosure.

### DETAILED DESCRIPTION

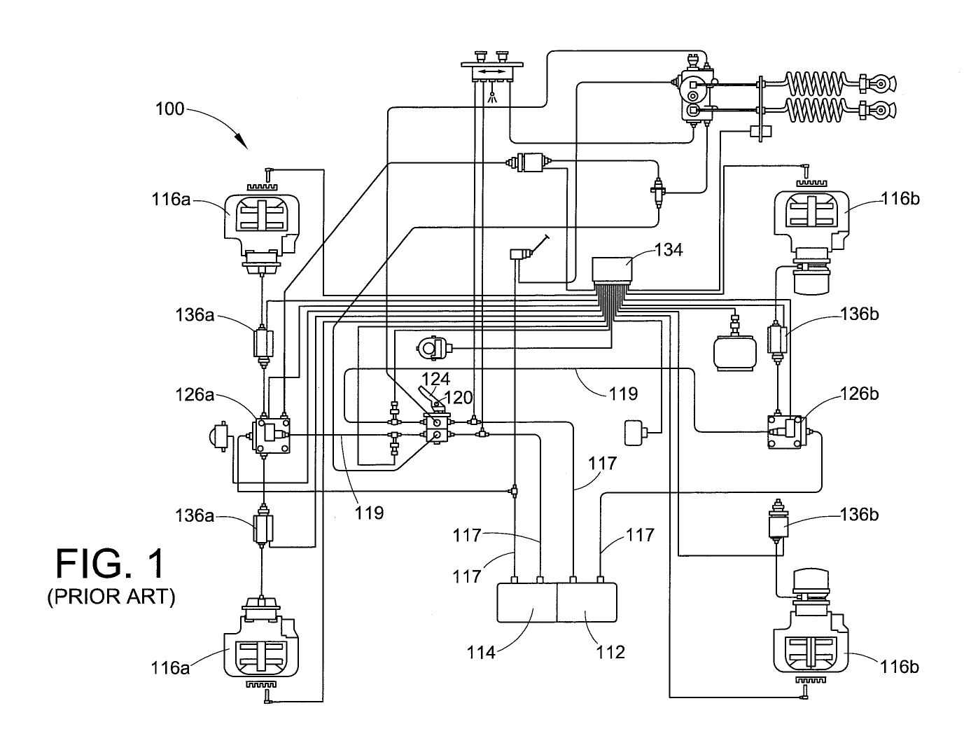

With reference to FIG. 1, an exemplary prior art air brake system is illustrated. The brake system 100 includes primary air reservoir 112 (typically for supplying a rear or trailer brake circuit) and secondary air reservoir 114 (typically for supplying a front or tractor brake circuit). The primary and secondary air reservoirs 112, 114 supply pressurized air to apply a set of front service brake assemblies 116a and rear service brake assemblies 116b. Air lines 117 communicate the pressurized air from the reservoirs 112, 114 to the brake assemblies 116a, 116b, via the various components of the system.

The air brake system 100 also includes a brake valve 120 having a foot pedal 124 that opens the valve when depressed. When open, the brake valve 120 allows pressurized air to flow from the reservoirs 112, 114 to relay valves 126a and 126b for actuating the service brakes.

Relay valves 126a and 126b also provide pressurized air to the brake assemblies 116a and 116b during automated braking operations. To this end, the relay valves 126a and 126b are connected to a controller 134 operative to actuate the valves 126a and 126b to supply pressured air when certain conditions exist warranting automated braking. Pressure modulating valves 136a and 136b are configured to modulate the actual pressure supplied to each respective brake assembly by exhausting some or all of the line pressure supplied by the relay valves to atmosphere.

A typical prior art air brake system may also include a variety of additional valves and components, as is known in the art. For example, tractor protection valves, quick release valves, spring brake valves, etc. are often employed. These valves and components are known in the art and are omitted from the discussion and illustration of the prior art and exemplary embodiments of the present invention for simplicity. The brake system according to the present invention, however, may utilize these and other valves and components. The illustrated brake system also includes a trailer brake circuit and other features that are shown but not described because such features are not necessarily germane to the following discussion.

During operation of the prior art brake system 100, when an operator requests braking power via pedal 124, a control pressure is communicated from brake valve 120 to relay valve 126a via line 119. During an automated braking event, the controller 134 sends a signal to the relay valves 126a and/or 126b to supply pressure to the brake assemblies 116a and/or 116b. The controller also sends a signal to one or more of the pressure modulating valves 136a and/or 136b to modulate the delivery of the pressure to the respective brake assemblies in a desired manner.

In the prior art brake system 100, if one of the relay valves 126a or 126b malfunctions (e.g., leaks or otherwise supplies unintended pressure to the brake assemblies) it may result in a slight application of pressure to the brake assemblies causing minor drag. This type of malfunction is not easily detected by the driver, but can reduce the vehicle's efficiency.

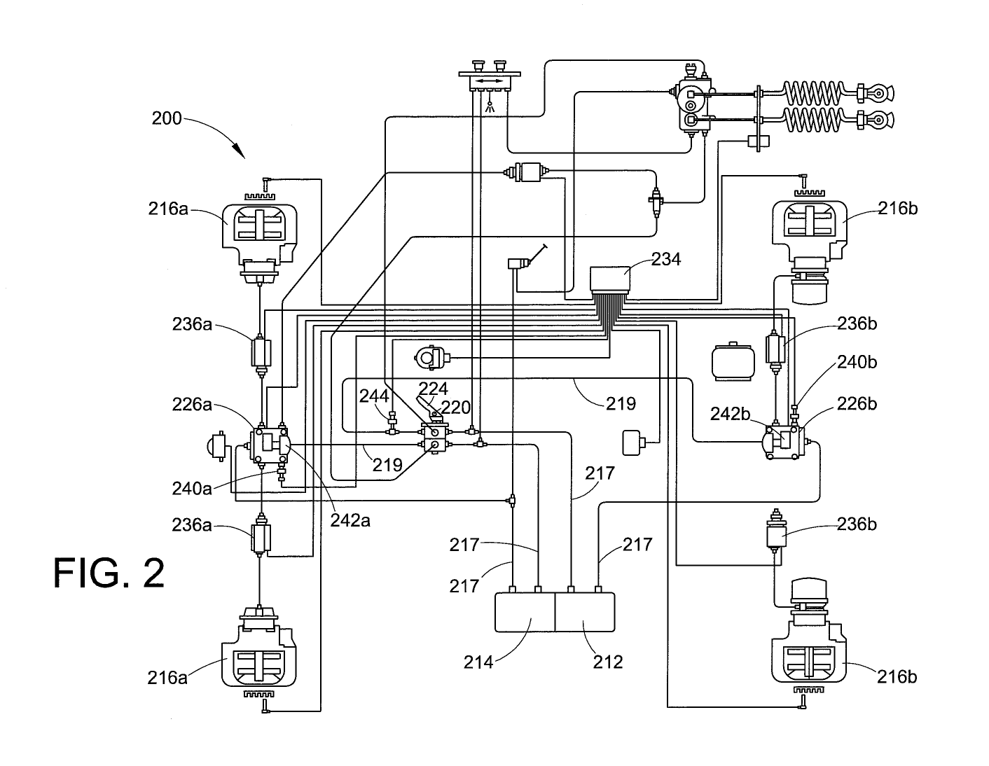

Turning now to FIG. 2, an exemplary brake system in accordance with the present disclosure is illustrated and identified generally by reference numeral 200. As will be described below, the brake system provides, among other things, a means for detecting a period of no braking, actuating a pressure modulator valve to vent the pressure delivery line to atmosphere, and detecting a change in pressure in the pressure delivery line resulting from the actuation of the pressure modulator valve.

The brake system 200 includes primary air reservoir 212 (typically for supplying a rear or trailer brake circuit) and secondary air reservoir 214 (typically for supplying a front or tractor brake circuit). The primary and secondary air reservoirs 212, 214 supply pressurized air to apply a set of front service brake assemblies 216a and rear service brake assemblies 216b. Air lines 217 communicate the pressurized air from the reservoirs 212, 214 to the brake assemblies 216a, 216b via the various components of the system.

The air brake system 200 also includes a brake valve 220 having a foot pedal 224 that opens the valve when depressed. When open, the brake valve 220 allows pressurized air to flow from the reservoirs 212, 214 to relay valves 226a and 226b for actuating the service brakes.

Relay valves 226a and 226b also provide pressurized air to the brake assemblies 216a and 216b during automated braking operations. To this end, the relay valves 226a and 226b are connected to a controller 234 operative to actuate the valves 226a and 226b to supply pressured air when certain conditions exist warranting automated braking. Pressure modulating valves 236a and 236b are configured to modulate the actual pressure supplied to each respective brake assembly by exhausting some or all of the line pressure to atmosphere.

As described to this point, the brake system 200 is similar to the brake system 100 of the prior art. However, unlike prior art brake systems, brake system 200 includes features for both detecting and mitigating the effects of a malfunctioning relay valve. More specifically, each relay valve 226a and 226b has a pressure sensor (transducer) 240a and 240b associated therewith for sensing pressure at a delivery port 242a, 242b of each respective valve. Each pressure transducer 240a and 240b is operatively connected to the controller 234 and can provide the controller with continuous pressure data which, as will be described, can be utilized to detect and/or mitigate the effects of a relay valve malfunction.

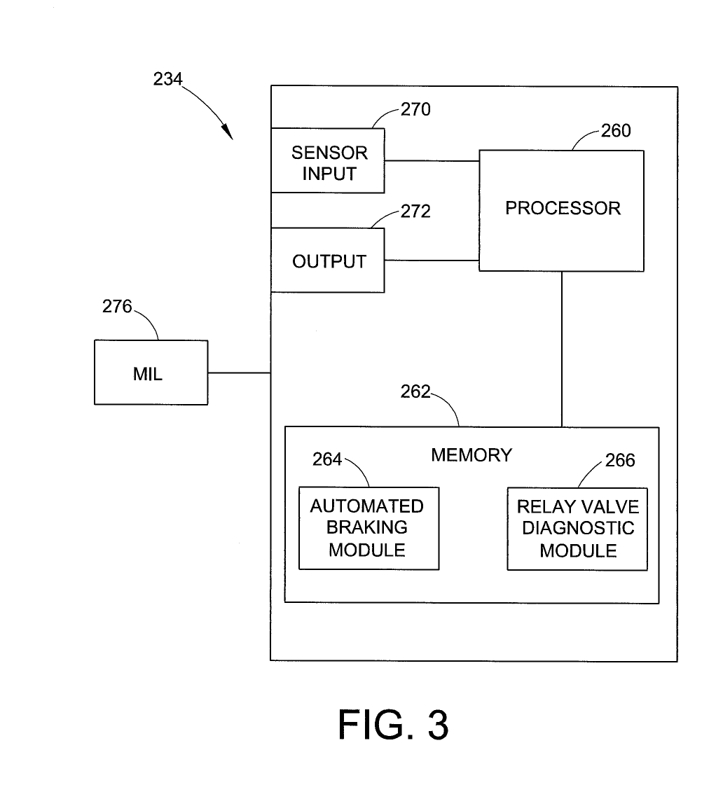

Turning to FIG. 3, controller 234 includes a processor 260 and a memory 262 in which an automated braking module 264 and a relay valve diagnostic module 266 are stored. Each module comprises computer-executable instructions carried out by the processor 260 to provide various automated braking and/or diagnostic functions. The controller 234 further includes a sensor/transducer input 270 for receiving data from one or more sensors (e.g., pressure transducers 240a, 240b), and an output 272 for outputting signals to various other components (e.g., the pressure modulating valves 236a, 236b). An optional Malfunction Indicator Lamp (MIL) 276 is connected to the controller. The MIL can be activated to warn a driver of potential problems, as will be described in more detail below. Although not illustrated, the controller can include multiple inputs/outputs for interfacing with a wide variety of vehicle components (sensors, valves, etc.)

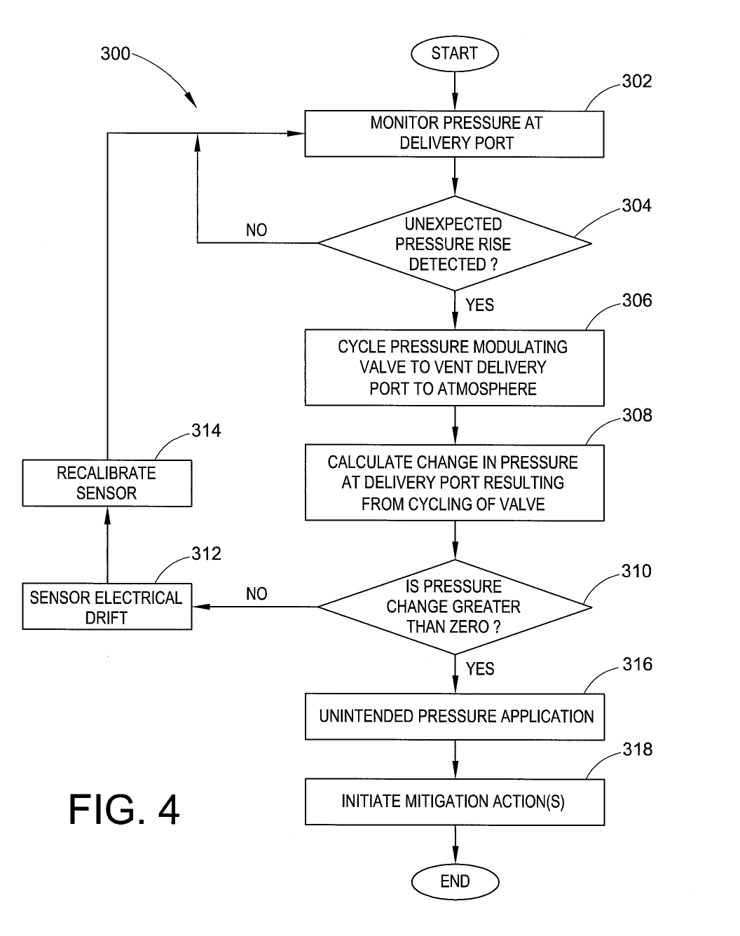

With reference to FIG. 4, an exemplary method of diagnosing a malfunctioning brake valve and/or mitigating the effects thereof in accordance with the present disclosure is illustrated. The method 300 will be described in the context of brake system 200 and begins at process step 302 with the monitoring of pressure at the delivery ports 242a, 242b of relay valves 226a, 226b. In the exemplary embodiment of FIGS. 2 and 3, pressure transducers 240a and 240b provide pressure information to controller 234. The pressure at each delivery port 242a, 242b can be continually monitored by controller 234 during vehicle operation. In process step 304, if an unintended rise in pressure at a delivery port of a particular relay valve is detected, then in process step 306 the pressure modulating valve associated with that relay valve is cycled momentarily to exhaust any pressure to atmosphere (if no unexpected pressure rise, the method loops back to process step 302). This venting is nearly instantaneous and preferably lasts less than 100 ms. It will be appreciated that the venting period is generally about the same amount of time as it might take to release the brake.

Relieving pressure from a delivery port when an unexpected pressure rise is detected provides at least two functions. First, it enables verification that the pressure transducer reading indicates an actual rise in pressure and is not the result of electrical drift. An actual pressure rise can be verified by comparing the pressure at the delivery port before and after the cycling of the pressure modulating valve. Under most circumstances, the pressure should drop after cycling thereby indicating that the pressure transducer is operating correctly. However, if the pressure rise is due to electrical drift, pressure would not drop after cycling. Second, cycling the valve(s) mitigates the effect of any unintended pressure application. That is, by exhausting the pressure, any brake drag resulting from such pressure is reduced/eliminated.

Accordingly, in process step 308 the change in pressure at the delivery port resulting from the cycling of the pressure modulating valve is calculated. At process step 310, if the change in pressure is zero (or less than a threshold value, for example about 2 psi to 4 psi) the method proceeds to process step 312 where the unexpected pressure rise is determined to be electrical sensor drift. The sensor can be recalibrated in process step 314, and then the method returns to process step 302 until an unexpected pressure rise is once again detected.

If the pressure change is greater than zero (or greater than a threshold value for example, about 2 psi to 4 psi) then at process step 316 the unexpected pressure rise is determined to be an actual pressure rise (not due to electrical drift), and at process step 318 various mitigation actions are implemented.

For example, the pressure modulating valves can be periodically cycled to continue releasing/decreasing the unintended pressure until such time as the malfunctioning valve can be repaired or replaced. In addition, the Malfunction Indicator Lamp (MIL) 276 located on the vehicle dashboard can be illuminated to indicate that the vehicle brake system requires service. Active systems using automated braking such as ATC, ESC, and External Brake Demand (XBR, used by adaptive cruise control and collision mitigation systems to automatically apply brakes) can be disabled to further mitigate potential failure effects.

In some cases, these various mitigation actions can be applied incrementally. For example, if the unintended pressure application is relatively minor (e.g., 1-4 psi), the system can be configured to simply illuminate the MIL to alert the driver to have the brake system serviced soon. If the unintended pressure application is moderate (e.g., 4-8 psi), the system can be configured to both illuminate the MIL and begin periodic cycling of the pressure modulating valves. If the unintended pressure application is relatively major (e.g., above 8 psi), the system can be configured to illuminate the MIL, periodically cycle the pressure modulating valves, and disable all vehicle features related to automated braking. In some applications, the various different automated braking features can be individually disabled. For example, it may be desired to disable all automated braking features except traction control under some instances. It will be appreciated that various thresholds can be established for when to disable each such function.

It will be appreciated that pressure modulating valves are typically designed to be reliable over a finite number of activations. Care generally must be taken in the periodic activation of the pressure modulating valves described above such that the number of activations does not exceed the design limit of the PMV over the life of the vehicle. One manner to achieve this is to install more robust pressure modulating valves. In most instances, however, cost considerations would dictate that existing pressure modulating valves be utilized.

Accordingly, the present disclosure contemplates limits on cycling of the pressure modulating valves and/or methods for reducing the number of required activations. For example, for a given axle, only one of a pair of pressure modulating valve needs to be cycled to perform the diagnostic functions or to release unintended pressure buildup. This is because the delivery port of each relay valve is connected to both brake units of a respective axle (e.g., supplies the same pressure to brake unit on each side). Thus, by cycling only one pressure modulating valve in each period, the number of cycles of the pair of pressure modulating valves on the axle is reduced.

It should be appreciated that, during service brake applications, the pressure transducers located at the relay valve delivery ports can be cross-checked with each other and with a pressure transducer 244 located at the delivery of the foot brake valve 220. This cross-check provides fault detection for failures in any of the three pressure transducers 240a, 240b and/or 244.

It should also be appreciated that aspects of the disclosure are directed to the periodic activation of the pressure modulating valves during normal vehicle operation to perform further diagnostics on the pressure transducers and to ensure that very small applications of pressure at the relay valves delivery (e.g.—less than 6 psi) can be reliably detected. For example, during times when no braking is occurring (manual or automated) and/or times when braking is not expected, the controller can be configured to cycle one or more of the pressure modulating valves to perform diagnostics on the valves and or transducers. By periodically performing the diagnostics, relatively low unintended pressure applications can be detected using existing pressure sensors/transducers.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of diagnosing a brake valve configured to supply pressurized fluid to a brake unit via a pressure delivery line during automated braking operations, the method comprising:
detecting a period of no braking activity;
venting the pressure delivery line to atmosphere during the period of no braking activity;
monitoring pressure in the pressure delivery line to detect a pressure change resulting from the venting; and
generating an error signal if a detected pressure change exceeds a threshold value.

2. The method of claim 1, wherein the venting is performed during the period of no braking activity when the pressure in the pressure delivery line is expected to be at or near atmosphere, whereby no change in pressure indicates a properly functioning valve.

3. The method of claim 2, wherein the detecting a period of no braking activity includes detecting a period of constant speed.

4. The method of claim 1, wherein the venting the pressure delivery line to atmosphere includes actuating a pressure modulator valve operatively connected between the brake valve and the brake unit.

5. The method of claim 1, wherein the monitoring includes using a pressure sensor located in a delivery port of the brake valve to detect pressure.

6. The method of claim 5, wherein the venting is performed after an unexpected increase in pressure is detected in the pressure delivery line, whereby no pressure change after venting indicates normal operation of the brake valve and the presence of electrical drift in a signal of the transducer resulting in the unexpected increase in detected pressure, and a pressure change after venting indicates a malfunctioning brake valve.

7. The method of claim 1, wherein the venting occurs nearly instantaneously, and preferably lasts for less than about 100 ms

8. The method of claim 1, further comprising taking mitigating action when an error signal is generated, the mitigating action including at least one of illuminating a warning lamp, periodically cycling the pressure modulator valve, or disabling one or more automated braking functions.

9. A brake system comprising:
at least one fluid pressure source;
at least one brake unit;
a pressure delivery line for delivering pressurized fluid to the at least one brake unit from the at least one fluid pressure source;
a brake valve for controlling the flow of pressurized fluid through the pressure delivery line to the at least one brake unit during automated braking operations, the brake valve operative to supply pressurized fluid to the at least one brake unit in response to a control signal;
a pressure sensor for sensing pressure in the pressure delivery line at a location between the brake valve and the pressure modulating valve;
a pressure modulator valve between the brake valve and the brake unit configured to exhaust the pressurized fluid to atmosphere when actuated; and
an electronic controller unit having an input for receiving data from the pressure sensor, an output for sending a control signal to the pressure modulator, a memory that stores computer-executable instructions, and a processor configured to execute the computer-executable instructions, the instructions comprising:
actuating the pressure modulator valve to vent the pressure delivery line to atmosphere;
calculating a pressure change resulting from the venting based on data received from the pressure sensor; and
generating an error signal if a detected pressure change exceeds a threshold value.

10. The system of claim 9, wherein the instructions further comprise actuating the pressure modulator valve during a period when the pressure in the pressure delivery line is expected to be at or near atmosphere, whereby no change in pressure indicates a properly functioning brake valve.

11. The system of claim 10, wherein the instructions further comprise monitoring both automated and manual braking activities for periods of when pressure is expected to be at or near atmosphere.

12. The system of claim 9, wherein the instructions further comprise monitoring the pressure sensor for an unexpected increase in pressure, actuating the pressure modulator valve to vent the pressure delivery line to atmosphere, and comparing the pressure before and after actuation of the pressure modulator valve, whereby no pressure change after venting indicates normal operation of the brake valve and the presence of electrical drift in a signal of the sensor, and a pressure change after venting indicates a malfunctioning brake valve.

13. The system of claim 9, wherein the instructions further comprise taking mitigating action when an error signal is generated, the mitigating action including at least one of illuminating a warning lamp, periodically cycling the pressure modulator valve, or disabling one or more automated braking functions.

14. An electronic controller unit for controlling an associated pressure modulator valve adapted to vent pressure from an associated pressure delivery line of a vehicle brake systems, the electronic controller unit comprising:
an input for receiving data from at least one sensor configured to sense pressure in the associated pressure delivery line;
an output for sending a control signal to the associated pressure modulator valve;
a memory that stores computer-executable instructions; and
a processor configured to execute the computer-executable instructions to generate the control signal, the instructions comprising:
monitoring data received from the at least one sensor;
generating a control signal to actuate the pressure modulating valve based on monitored data;
transmitting the control signal to the pressure modulating valve via the output to vent the pressure delivery line;
detecting a pressure change resulting from the actuation of the pressure modulating valve;
comparing the detected pressure change to a threshold value; and
generating an error signal if the detected pressure change exceeds the threshold value.

15. The controller unit of claim 14, wherein the instructions further comprise actuating the pressure modulator valve during a period when the pressure in the pressure delivery line is expected to be at or near atmosphere, whereby no change in pressure indicates a properly functioning brake valve.

16. The system of claim 15, wherein the instructions further comprise monitoring both automated and manual braking activities for periods of inactivity.

17. The system of claim 14, wherein the instructions further comprise monitoring the pressure sensor for an unexpected increase in pressure, actuating the pressure modulator valve to vent the pressure delivery line to atmosphere, and comparing the pressure before and after actuation of the pressure modulator valve, whereby no pressure change after venting indicates normal operation of the brake valve and the presence of electrical drift in a signal of the sensor, and a pressure change after venting indicates a malfunctioning brake valve.

18. The system of claim 14, wherein the instructions further comprise disabling at least one automated braking feature when an error signal is generated.

19. A brake system comprising:
at least one fluid pressure source;
at least one brake unit;
a pressure delivery line for delivering pressurized fluid to the at least one brake unit from the at least one fluid pressure source;
a brake valve for controlling the flow of pressurized fluid through the pressure delivery line to the at least one brake unit during automated braking operations, the brake valve operative to supply pressurized fluid to the at least one brake unit in response to a control signal;
a pressure sensor for sensing pressure in the pressure delivery line at a location between the brake valve and the brake unit; and
means for detecting a period of no braking, actuating the pressure modulator valve to vent the pressure delivery line to atmosphere, and detecting a change in pressure in the pressure delivery line resulting from the actuation of the pressure modulator valve.

20. A method of diagnosing a brake valve configured to supply pressurized fluid to a brake unit via a pressure delivery line during automated braking operations, the method comprising:
venting the pressure delivery line to atmosphere after an unexpected increase in pressure is detected in the pressure delivery line;
monitoring pressure in the pressure delivery line to detect a pressure change resulting from the venting, whereby no pressure change after venting indicates normal operation of the brake valve and the presence of electrical drift in a signal of the transducer resulting in the unexpected increase in detected pressure, and a pressure change after venting indicates a malfunctioning brake valve; and
generating an error signal if a pressure change is detected.

21. The method of claim 20, further comprising:
detecting a period of no braking activity; and
venting the pressure delivery line to atmosphere during the period of no braking activity.

22. The method of claim 20, wherein the venting the pressure delivery line to atmosphere includes actuating a pressure modulator valve operatively connected between the brake valve and the brake unit.

23. The method of claim 20, further comprising:
taking mitigating action when an error signal is generated, the mitigating action including at least one of illuminating a warning lamp, periodically cycling the pressure modulator valve, or disabling one or more automated braking functions.
